(19) United States
(12) Patent Application Publication
(10) Pub. No.: US 2010/0166494 A1
(43) Pub. Date: Jul. 1, 2010

(54) DEVICE FOR FASTENING AN ADD-ON PART, WHICH IS FORMED WITH TONGUE-LIKE PROJECTIONS, TO A SUPPORT PART

(75) Inventor: Mathieu Cochard, La Tronche (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/160,501

(22) PCT Filed: Jan. 11, 2007
(86) PCT No.: PCT/EP2007/000184

§ 371 Date: Jul. 10, 2008

(30) Foreign Application Priority Data
Jan. 26, 2006 (DE) 10 2006 003 663.8

(51) Int. Cl. F16B 7/00; F16B 17/00

(52) U.S. Cl. 403/52; 403/345; 403/220

(57) ABSTRACT

A device for fastening an add-on part, which is formed with tongue-like projections, to a support part has members (1, 2) which are connected to one another. At least a number of the members (1, 2) has a cage wall (3) which surrounds a receiving space (14) and on which is formed a ramp structure (13) which projects into the receiving space (14) and has an inclined piece, which rises obliquely from an inlet side to an outlet side of the respective member (1, 2), and a stop piece. The stop piece has a greater spacing from a contact side of the cage wall (3) than that region of the inclined piece which is adjacent to the inlet side. In this way, when the ramp structure (13) is in engagement with pins which are attached to the support part, the members (1, 2) press against the tongue-like projections and fasten the add-on part to the support part.

### CROSS-REFERENCE TO RELATED APPLICATION

This application is a U.S. National Phase Patent Application based on International Application Serial No. PCT/EP2007/000184 filed Jan. 11, 2007, the disclosure of which is hereby explicitly incorporated by reference herein.

### BACKGROUND OF THE INVENTION

1. Field of the Invention

The invention is directed to a device for fastening an add-on part configured with tongue-like projections to a support part.

2. Description of the Related Art

In conventional ways of fastening an add-on part formed with tongue-like projections to a support part, the tongues are often provided with cutouts that come into engagement with catch noses or catch pins disposed on the support part. A disadvantage of these embodiments, however, is that the connection is often impossible or very difficult to release. In addition, very close tolerances have to be maintained for engagement to be realized in the first place.

### SUMMARY OF THE INVENTION

The present invention provides a device for fastening an add-on part configured with tongue-like projections to a support part, by means of which the add-on part can be reliably connected to the support part even in cases where exact dimensional accuracy has not been maintained, and can also be detached from it in a simple manner.

By virtue of the configuration of the inventive device, the members of the device can be gradually arranged by their respective entrance sides on pins configured with a broadened head and connected to the support part, and can be displaced so that the head slides along the ramp structure, and, after being positioned in the region of the retaining piece, the tongue-like projections of the add-on part press against the support part, thereby fixing the add-on part. After another movement of the members, the heads slide along to the exit side until the inventive device is free again. In this way, the add-on part can be connected repeatedly and, in particular, nondestructively to the support part.

In one form thereof, the present invention provides a device for fastening an add-on part configured with tongue-like projections to a support part and including members that are connected to one another, at least a number of the members having a cage wall which surrounds a receiving space and on which is formed a ramp structure that projects into the receiving space and includes an inclined piece, which rises obliquely from an entrance side to an exit side of the respective member, and a retaining piece, the retaining piece being at a greater distance from a contact side of the cage wall than that region of the inclined piece which is adjacent to the entrance side.

Further advantageous embodiments of the invention are the subject matter of the dependent claims.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view, looking at a top side, of an exemplary embodiment of a device according to the invention having a terminating-side end member and a number of intermediate members connected to said end member;

FIG. 2 is a perspective view of an intermediate member of the exemplary embodiment according to FIG. 1, looking at a contact side located oppositely from the top side;

FIG. 3 is a sectional view of the exemplary embodiment according to FIG. 1 in a pre-mounting position, before the fastening of an add-on part to a support part;

FIG. 4 shows the arrangement according to FIG. 3 with the exemplary embodiment according to FIG. 1 in a fixing position; and

FIG. 5 shows the arrangement according to FIG. 3 and FIG. 4 with the exemplary embodiment in a releasing position.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

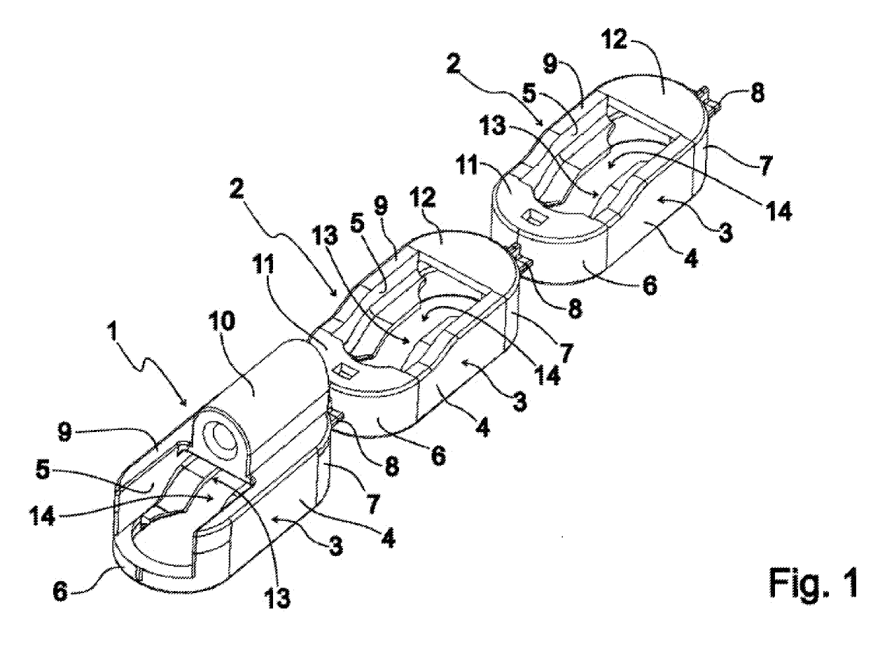

FIG. 1 is a perspective view of an exemplary embodiment of a device according to the invention, comprising a number of members, which in the partial view of FIG. 1 are configured as one terminating-side end member 1 and a number of intermediate members 2 connected to said end member 1. Both end member 1 and intermediate members 2 have a circumferentially closed cage wall 3 comprising two spaced-apart, mutually parallel side portions 4, 5 and two also mutually opposite, curved end portions 6, 7 that join side portions 4, 5 together. End member 1 and intermediate members 2 are connected to one another by intermediate connecting pieces 8, which in the described exemplary embodiment are configured as one-piece, flexible elements such that members 1, 2 can be tilted and rotated with a certain bias.

In an exemplary embodiment not shown, the connecting pieces comprise an articulation which enables members 1, 2 to be tilted and rotated similarly as in the illustrated and described exemplary embodiment.

End member 1 is provided, on its side facing toward the adjacent intermediate member 2, with a bolt receiving bushing 10 mounted on a top side 9 and serving as a thread arrangement, and into which a bolt (not shown in FIG. 1) can be screwed from the side facing away from adjacent intermediate member 2. Intermediate members 2, for their part, are configured on their respective top sides 9 with edge caps 11, 12 covering the end portions 6, 7.

It can further be seen from FIG. 1 that both end member 1 and intermediate members 2 are each configured with a ramp structure 13, which extends from side portions 4, 5 into a receiving space 14 enclosed by the cage wall 3.

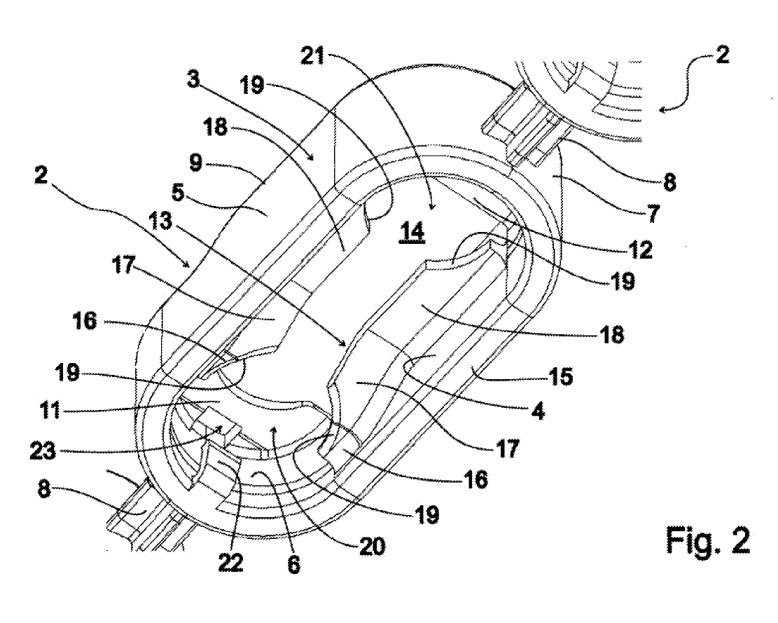

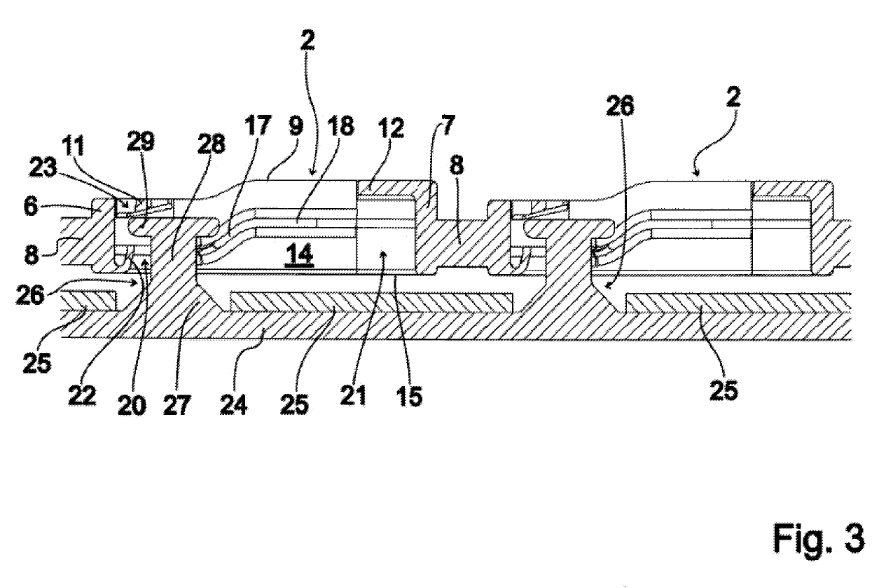

FIG. 2 is a perspective view of an intermediate member 2 of the exemplary embodiment according to FIG. 1, looking at a planar contact side 15 of cage wall 3, which side is located oppositely from top side 9 and lies in a plane. It can be seen from FIG. 3 that the ramp structure 13 of each intermediate member 2 comprises two entrance pieces 16 which are oriented substantially parallel to contact side 15, and each of which is attached to a side portion 4, 5 at the side facing toward end member 1 and extends into receiving space 14. Each entrance piece 16 merges into an inclined piece 17 of ramp structure 13, which is also connected to side portions 4, 5, and is set at an angle such that starting at the end facing toward the particular entrance piece 16, it rises from contact side 15 in the direction of top side 9. Formed on the end of each inclined piece 17 facing away from the particular entrance piece 16 is a flat retaining piece 18 that is part of the ramp structure 13 and also extends parallel to contact side 15.

The ramp structure 13 formed by entrance pieces 16, inclined pieces 17 and retaining pieces 18 has roundish indentations 19 at its ends facing toward end portions 6, 7 of cage wall 3, thereby creating, at an entrance side 20 facing toward end member 1 and an exit side 21 facing away from end member 1, areas of wider cross section than the other portions of ramp structure 13.

Formed on entrance side 20 is a flexible, tongue-like catch nose 22 that extends from contact side 15 into receiving space 14. Opposite catch nose 22, the edge cap 11 located in the region of entrance side 20 has an access opening 23 through which a releasing tool coming from the top side 9 can be passed in order to manipulate catch nose 22.

For the sake of completeness, it should be noted at this juncture that, at least in the region of ramp structure 13, end member 1 is constructed in the same manner as intermediate member 2, except that the former has no edge cap 11 in the region of entrance side 20, it does not have a catch nose 22, and its end portion 6 does not reach all way from contact side 15 to top side 9.

FIG. 3 is a sectional view of the exemplary embodiment according to FIG. 1 and FIG. 2 in the region of intermediate members 2, together with a support part 24 and add-on part tongues 25, as projections of an add-on part, which are disposed between fastening pins 26 connected to support part 24. Each fastening pin 26 is connected to the support part 24 via a pin foot 27 of thickened cross section, and extends away from support part 24 by a substantially cylindrical pin shaft 28. Attached to each pin shaft 28 is a disk-like pin head 29 that projects circumferentially beyond pin shaft 28.

In the arrangement according to FIG. 3, the exemplary embodiment of the inventive device is in a pre-mounting position in which each pin head 29 has entered receiving space 14 at entrance side 20, accompanied by deflection of the catch noses 22 configured on intermediate members 2. The presence of the edge caps 11 in the region of entrance side 20 ensures that, assuming that pin shaft 28 is properly dimensioned in its longitudinal direction, end member 1 and intermediate members 2 will be disposed with their respective contact sides 15 at a distance from support part 24 that is greater than the thickness of add-on part tongues 25. The add-on part can thus be positioned in a substantially resistance-free manner, owing to the free mobility of add-on part tongues 25.

Due to the rear engagement of pin heads 29 by catch noses 22, the inventive device is connected to support part 24 in a way that protects it against inadvertent removal, while at the same time this connection can still be released by suitable manipulation of the catch noses 22, for example by means of a releasing tool inserted through access openings 23.

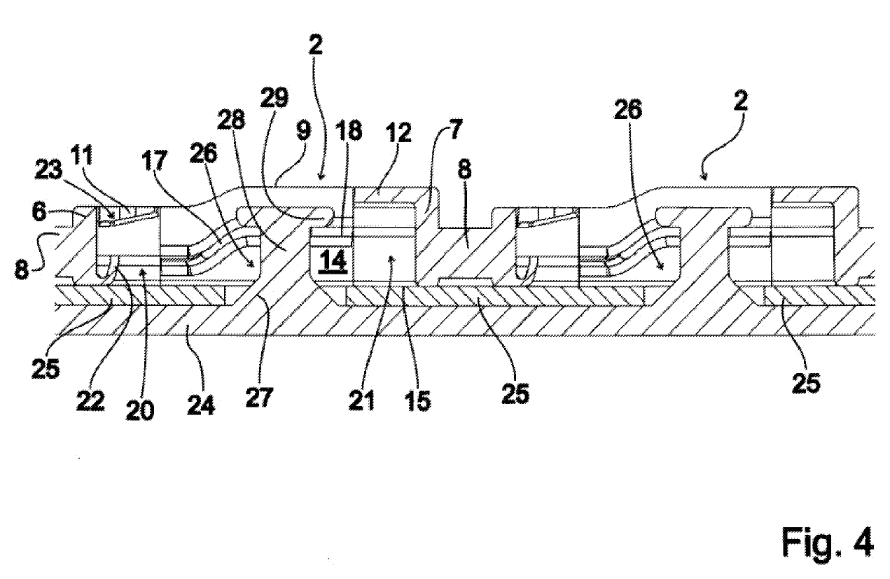

FIG. 4 shows the arrangement according to FIG. 3 with the inventive device in a fixing position, which has been assumed by moving the inventive device relative to the fastening pins 26 out of the pre-mounting position according to FIG. 3 in such a way that the pin heads 29 are slid up along inclined pieces 17 until they are resting on the retaining pieces 18 of ramp structure 13. In this regard, the distance of retaining pieces 18 from contact side 15 is chosen to be equal to the distance between the side of pin head 29 facing toward support part 24 and the side of support part 24 facing toward add-on part tongues 25, minus the thickness of add-on part tongues 25, or, to increase the clamping effect, is preferably slightly smaller that said distance, so that the add-on part tongues 25 are pressed against the support part 24 over a large area and the add-on part is connected to the support part 24.

The relative movement of members 1, 2 with respect to support part 24 is obtained, in the depicted and described exemplary embodiment, by the fact that a bolt engaging through an erect side wall of support part 24, and constituting part of a tensioning and engaging arrangement, comes into engagement with the bolt receiving bushing 10 of end member 1 and is screwed in to an extent such that the fixing position according to FIG. 4 is assumed. The resulting blocking of movement also protects the inventive device against inadvertent displacement.

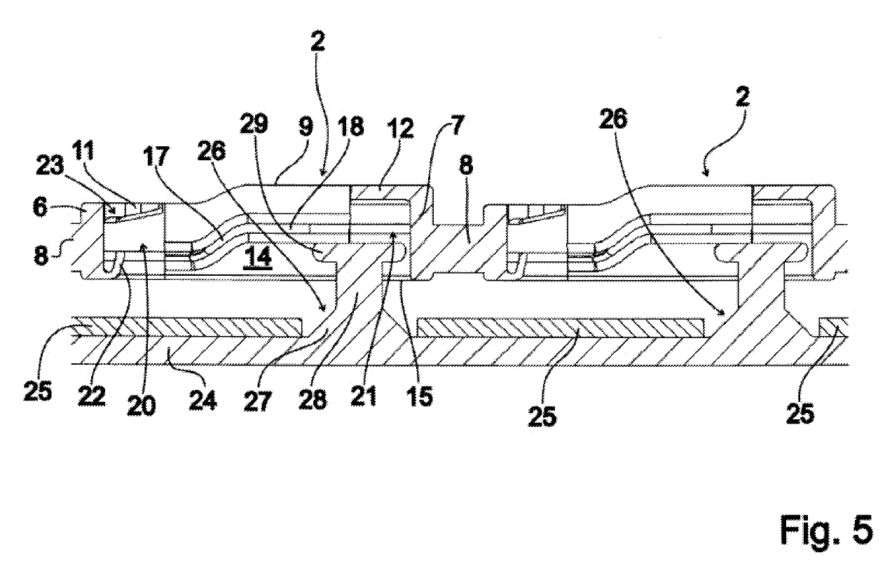

FIG. 5 shows the arrangement according to FIG. 3 and FIG. 4 in a releasing position, in which, starting from the fixing position according to FIG. 4, the inventive device is displaced until the pin heads 29 are disposed in the region of the exit sides 21 of members 1, 2 and, by virtue of the widening produced by the indentations 19, are able to exit from the receiving spaces 14. In this releasing position, the add-on part tongues 25 are free again and the inventive device can be removed from carrier part 24 without tool support.

It is understood that for the releasing position according to FIG. 5 to be assumed, any blocking of movement of the inventive device, for example such as that described in connection with FIG. 4 and brought about by engagement with a bolt, must be released and the bolt must be screwed farther into bolt receiving bushing 10 until the releasing position is assumed, and the bolt is then rotated out in order to cancel the blocking of movement.

An embodiment not shown provides for a tensioning and engaging arrangement comprising a lifting mechanism that is connected to the end member and can be brought releasably into engagement with support part 24, and, upon the actuation of the members 1, 2 of the inventive device, moves in the longitudinal direction from the pre-mounting position according to FIG. 3 into the fixing position according to FIG. 4 and from the fixing position according to FIG. 4 into the releasing position according to FIG. 5.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A device for fastening an add-on part, configured with tongue-like projections, to a support part, comprising:
a plurality of members connected to one another, at least some of said members having a cage wall surrounding a receiving space, the receiving space including a ramp structure projecting into said receiving space, and an inclined piece rising obliquely from an entrance side to an exit side of each respective said member, and a retaining piece disposed at a greater distance from a contact side of said cage wall than a region of said inclined piece that is adjacent to said entrance side.

11. The device of claim 10, wherein said members are connected to one another via flexible, one-piece connecting pieces.

12. The device of claim 10, wherein said members are connected to one another via connecting pieces which each include an articulation.

13. The device of claim 10, further comprising caps disposed at said entrance side and at said exit side on a top side of said cage wall disposed opposite from said contact side.

14. The device of claim 10, further comprising a flexible catch nose extending into said receiving space and disposed on said contact side proximate said entrance side.

15. The device of claim 10, wherein said ramp structure includes, at said entrance side and at said exit side, indentations that widen the cross section of said ramp structure.

16. The device of claim 10, further comprising a terminating-side member including a tensioning and engaging arrangement provided to effect connection with said support part and which, when actuated, moves said members, relative to an arrangement of pins connected to said support part, from a pre-mounting position into a fixing position.

17. The device of claim 16, wherein said tensioning and engaging arrangement includes a thread arrangement for engagement with a bolt secured to said carrier part.

18. The device of claim 16, wherein said tensioning and engaging arrangement includes a lifting mechanism releasably engageable with said support part.
